(19) United States
(12) Patent Application Publication
(10) Pub. No.: US 2006/0112781 A1
(43) Pub. Date: Jun. 1, 2006

(54) Multi-motor/multi-range torque transmitting power system

(76) Inventors: Brian Kuras, Metamora, IL (US); Michael Vanderham, East Peoria, IL (US); Kent Casey, Washington, IL (US)

Correspondence Address: Michael B. McNeil;Liell & McNeil Attorneys PC, P.O. Box 2417, Bloomington, IN, 47402, US

(21) Appl. No.: 10/999,390

(22) Filed: Nov. 30, 2004

(51) Int. Cl. F16H 37/06

(52) U.S. Cl. 74/661

(57) ABSTRACT

torque transmitting power system includes first and second motors operably coupled to an output shaft via respective first and second transmissions. At least one of the two transmissions has at least two ranges. A power supply subsystem includes an engine with an output operably coupled to an input of an energy conversion device, which is operably coupled to an input of the first motor and an input of the second motor. The system allows for speed shifts that can be accomplished in a way that maintains rimpull during the shift event for smoother accelerations.

### TECHNICAL FIELD

The present disclosure relates generally to torque transmitting powers systems, and more particularly to multi motor/multi range torque transmitting power systems.

### BACKGROUND

In the past, a conveyance typically included an engine operably coupled to a rotatable member via a transmission. The conveyance could be a boat with the rotatable member being a propeller, it could be a track type work machine with the rotatable member being a sprocket, or could be a conventional motor vehicle in which the rotatable member is one or more tires. One problem that has been recognized with regard to such conveyances, especially heavy slow moving conveyances, is to maintain rimpull when the transmission is being shifted between ranges, such as between a low and high range. In other words, when the conveyance is undergoing a shift, the engine is briefly completely decoupled from the rotatable member while the transmission is being changed between ranges, and then is subsequently reengaged to apply torque to the rotatable member. Although relatively brief, this coupling between the engine and the rotatable member can result in less than smooth operation which can undermine the performance of the conveyance, such as a work machine, and can otherwise be perceived by an operator as annoying or problematic.

In more recent years, there has been a trend toward augmenting the simple torque transmitting power system of the past with one or more motors that may be in parallel or in series with an engine. For instance, co-owned U.S. Pat. No. 6,371,882 to Casey et al. shows a control system and method for multi range continuously variable transmission using mechanical clutches. In that system, an engine and two motor/generators are operably coupled to each other and an output shaft via several planetary gear sets. While the Casey et al. device can provide for a continuously variable transmission, it is relatively complex in construction and may not be suitable for some conveyances that simply need more than one transmission range to effectively operate.

The present disclosure is directed to overcoming one or more of the problems set forth above.

### SUMMARY OF THE DISCLOSURE

A torque transmitting power system includes a rotatable output shaft. First and second motors are operably coupled to the output shaft via first and second transmissions, respectively. At least one transmission has at least two ranges. A power supply sub-system includes an engine with an output operably coupled to an input of an energy conversion device, which is operably coupled to an input of the first motor and the input of the second motor.

In still another aspect, a speed shift is preformed at least in part by sequentially disengaging one, but not both, of the first and second motors from the output shaft via one of the first and second transmissions respectively. The range of the transmission associated with the disengaged motor is changed. Then, the disengaged motor is re-engaged with the output shaft via the one of the first and second transmissions, respectively.

### BRIEF DESCRIPTION OF THE DRAWINGS

FIG. 1 is a system schematic for the conveyance of FIG. 1; and

FIGS. 2a-2f are a series of graphs of first motor speed, first motor power, second motor speed, second motor power, output shaft power and output shaft speed versus time when the conveyances are undergoing an up shift.

### DETAILED DESCRIPTION

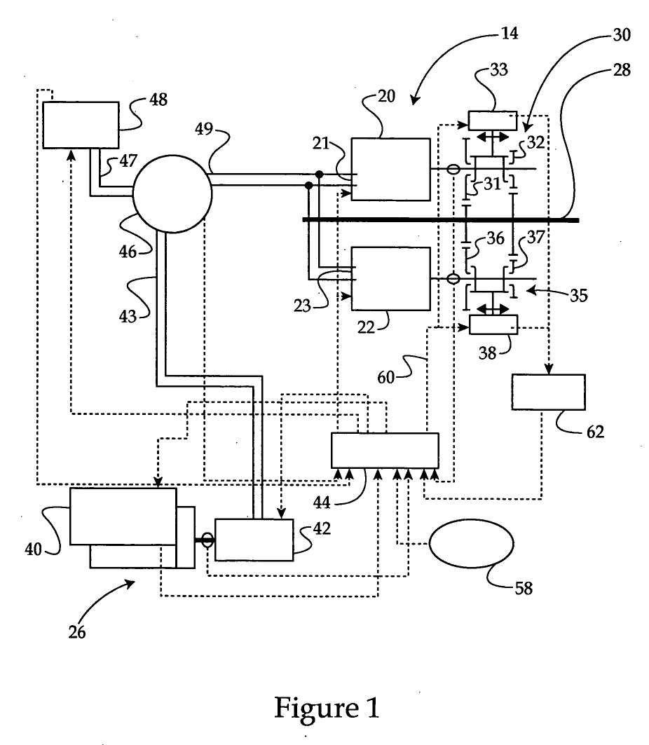

Referring to FIG. 1 torque transmitting power system 14 includes a first motor 20 and a second motor 22 operably coupled to output shaft 28 via respective first transmission 30 and second transmission 35. Although the power system 14 is illustrated as including two equally sized motors, the disclosure contemplates three or more dissimilar sized motors, with each being operably coupled to an output shaft via a respective transmission. The first transmission 30 includes a high range 31 and a low range 32 that are engagable via an electronically controlled clutch actuator 33 in a conventional manner. Likewise, second transmission 35 includes a high range 36 and a low range 37 that are engagable via a second electronically controlled clutch actuator 38 in a conventional manner. Although the illustrated embodiment shows each of the first and second transmissions 30 and 35 having two ranges, this disclosure contemplates a simpler system in which only one of the plurality of transmissions has at least two ranges. Likewise, the present disclosure contemplates a more complex system in which one or more of the transmissions has three or more ranges. Thus, at its threshold, the present disclosure contemplates a torque transmitting power system 14 with at least two motors 20 and 22 that are operably coupled to an output shaft 28 via respective transmissions 30 and 35, at least one of which has at least two different ranges.

In a preferred embodiment, first and second motors 20 and 22 are electric motor/generators that can generate torque to output shaft 28, or generate power as a generator from torque supplied to the respective motor/generator from output shaft 28. In most instances, output shaft 28 will be supplied with torque from both the first motor 20 and the second motor 22 via their respective transmissions 30 and 35. First and second motors 20 and 22 are preferably powered by a power supply subsystem 26 that includes an engine 40 that is operably coupled to an energy conversion device 42. Although energy conversion device 42 could be operably coupled directly to the respective inputs 21 and 23 of first and second motors 20 and 22, it preferably supplies power to a common bus 46 via a supply conduit 43. In the preferred version illustrated, energy conversion device 42 is a generator(s), common bus 46 is a voltage bus and supply conduit 43 includes conventional wiring of a type known in the art. Power is supplied to the respective input 21 and 23 of the first and second motors 20 and 22 via an energy supply/return conduit 49 that is connected to common bus 46. In an alternative embodiment, energy conversion device 42 would be a hydraulic pump(s), common bus 46 would be a pressurized hydraulic manifold, and first and second motors 20 and 22 would be hydraulic motors/pumps. In this alternative, conduits 43 and 49 would be hydraulic fluid conduits rather than electrical wiring as in the preferred embodiment. Although not necessary, the torque transmitting power system 14 can include an energy storage device 48 that is operably coupled to the common bus 46 via a storage conduit 47. For instance, energy storage device 48 could be one or more capacitors, one or more batteries, or possibly be even a variable volume accumulator in the case of the hydraulic alternative.

Although not necessary, the entire torque transmitting power system 14 can be electronically controlled via an appropriately programmed electronic control module 44 in a conventional manner. In particular, the electronic control module 44 acts as a supervisory controller that supplies electronic control signals to clutch actuators 33 and 38, a speed or torque control signal to first motor 20 and second motor 22, a clutch actuator command signal delivered by way of transmission control communication line 60, a storage or release command control signal to the energy storage device 48, an engine control command to engine 40, an energy conversion device output control command to energy conversion device(s) 42 could be a torque command or displacement command depending on the device. These control signals will be preferably based upon a variety of sensor inputs including an operator input 58, a clutch status communication line 62, motor speed sensors, an engine speed sensor, other known engine feedback sensors, an energy storage level/status input, and finally a common bus status sensor. Those skilled in the art will appreciate that other electronically controlled devices and/or sensors could be operably coupled to the electronic control module 44 without departing from the intended scope of the present disclosure.

### INDUSTRIAL APPLICABILITY

The present disclosure potentially applies to any torque transmitting power system regardless of whether the power system is mounted on a moveable vehicle body, such as a boat, car or work machine, but also could find potential application in stationary systems where the torque transmitting power system is used to supply torque to one or more other apparatuses. The disclosure is illustrated as entirely electronically controlled, the present disclosure could also find application in less sophisticated systems, including in the extreme systems that are entirely mechanically and/or manually controlled directly.

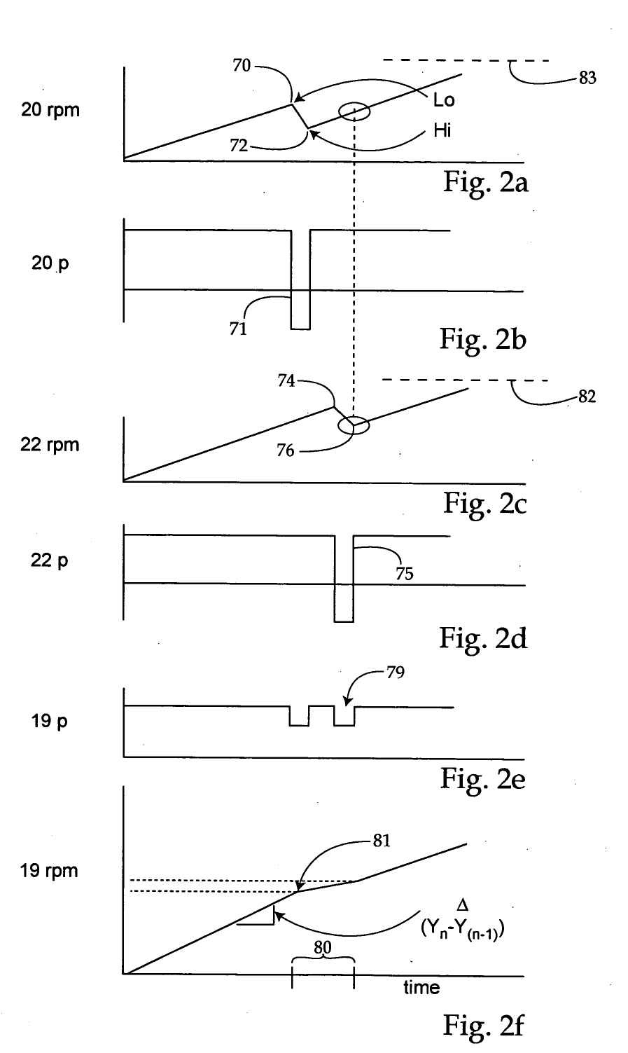

The torque transmitting power system 14 illustrated in FIGS. 1 and 2 allows for several improvements over single motor multi-range transmission systems. For instance, the torque requirement for each individual motor can be reduced relative to that of a single motor. The size reduction can result in a corresponding cost reduction, even acknowledging that the present disclosure contemplates replacing a single motor with two or more smaller motors. The power system also allows for torque interruption during a shift event between ranges to be minimized, thus allowing the machine to maintain some value of rimpull during the shift event. In addition, the shift event can be made sequentially between the motors allowing for improved shift smoothness over that of a single motor system. In addition, the control algorithms, with regard to the torque transmitting power system 14 illustrated earlier, can allow for synchronized shift events that can in turn allow for utilization of smaller, simpler clutch mechanisms and reduced transmission cooling requirements. On the other hand, if synchronized shifting is undesirable, the configuration can be adapted to utilize standard power shift clutching to achieve range shifts.

Referring now in addition to FIGS. 2a-f, an example up shift event according to the present disclosure is illustrated. Before the shift event, the output shaft 28 is rotated by simultaneously engaging the first and second motors 20 and 22 to the output shaft 28 via the first and second transmissions 30 and 35, respectively. At this point, both transmissions are operating in their respective low ranges 32 and 37. As the operator asks for increased speed through an appropriate operator input command 58, such as via a foot pedal, the electronic control module 44 responds with commands to increase the motor speeds of motors 20 and 22. As the motor speeds increase, they will eventually reach a predetermined automatic or a manually desired machine shift speed. When that point is reached, the clutch actuator 33 disengages motor 20 from output shaft 28 as shown in event 70 of FIG. 2a. As expected, FIG. 2b shows that the output shaft power from motor 20 drops to slow the motor 20 down as shown in event 71. This corresponding power drop is also reflected in the output shaft power as shown by event 79 in FIG. 2e. Also, FIG. 2f shows that during the shift event 81, the rotation rate of the output shaft 28 continues to increase at a slower rate, which reflects the fact that during this period of disengagement of motor 20, only motor 22 continues to apply rimpull or torque to the output shaft 28. The duration or overall shift time 80 of the shift event 81 can be determined by the rate of change of the final desired output shaft speed, which includes the operator input 58, and the second motor 22 shift speed limit. In other words, the system is preferably operated in such a way that both motor 20 and motor 22 do not exceed a predetermined respective maximum speeds. Preferably, there is an attempt to synchronize the speed of motor 20 by decelerating the same to meet the oncoming high range clutch 31. Those skilled in the art will recognize that when motor 20 is decelerating, it can potentially operate as a generator and produce electric power, or operate as a pump in the case of the hydraulic alternative. This generated power can then be used by motor 22 to minimize the necessity for additional engine power demand, or power demand from the energy storage device 48 during the shift event 81. Alternatively, this generated power can be returned to the common bus 46 for storage in energy storage device 48 in a manner well known in the art. Preferably, the common bus 46 DC voltage control algorithm included in electronic control module 44, the motor power demand and motor limit maps, which are also stored in a manner available to the electronic control module 44, manage the amount of power utilized by motor 22 during the shift event. In other words, this is accomplished in such a way that, as shown in FIG. 2c, motor 22 continues to accelerate while motor 20 is disengaged. This strategy can also allow a percentage of the power at the output shaft 28 to be maintained. With the addition of the optional energy storage device 48, the power generated by the decelerating motor 20 can be shared between the engaged motor 22 and the energy storage device 48. Depending upon the desired level of acceleration and designed cooling, the motors 20 and 22 could use continuous and/or intermittent increased torque/power capability to complete the shift event 81.

When motor 20 is sufficiently decelerated to match the oncoming high range, it is reengaged at event 72 as shown in FIG. 2a. This reengagement is revealed in FIG. 2b by motor 20 resuming to provide power to the output shaft 28 when reengaged. Shortly thereafter, and before motor 22 reaches its speed limit 82, it is disengaged via second transmission 35 as shown at event 74 in FIG. 2c. This disengagement is also revealed in FIG. 2d by the sudden drop in power output from motor 20, 22 as shown at event 75 in FIG. 2d. While this is occurring, motor 20 is commanded to accelerate as shown by the upward slope in FIG. 2a and the continued speed increase of output shaft 28 as shown during the shift event 81 in FIG. 2f. Before motor 22 is reengaged at event point 76 in FIG. 2c, it is decelerated to match its speed with the oncoming high range 36, which is partially determined by the speed of the output shaft 28 as influenced by the engaged motor 20 as earlier. When motor 22 is being decelerated, it can potentially generate power that can be retrieved and stored in the energy storage device 48. When the speeds are synchronized, motor 22 is reengaged at event 76, and this reengagement is revealed in FIG. 2d by the resumption of power output from motor 22 to the output shaft 28. In addition, now both motors 20 and 22 are reengaged at their respective high ranges 31 and 36, and the output shaft power is returned to its preshift level as shown in FIG. 2e, and the acceleration rate is now increased as shown in FIG. 2f since both motors 20, 22 are now supplying power to the output shaft 28. Those skilled in the art will appreciate that traditional anti/hunt strategies can be wrapped around the shift control logic to prevent the motors 20 and 22 from transitioning in and out of specific ranges.

Those skilled in the art will appreciate that by specifying a down shift speed limit for motor 20, the up shift logic can be used in reverse to accomplish down shift control. The additional energy needed to complete a range shift can be provided by the energy storage device 48 so as to preferably maintain engine 40 in a more steady state operating condition. When down shifting, the disengaged motor will be required to speed up to synchronize with the low range. In the event that an outside retarding torque is being applied to output shaft 28 during this event, the engaged motor can operate as a generator and provide some of the needed power to raise the speed of the disengaged motor to synchronize it with the oncoming lower range. Preferably, the supervisory controller in the electronic control module 44 will calculate a desired shift duration from available information.

In the event that the output shaft 28 is receiving a retarding torque, the motors 20, 22 can be placed in a generating mode, and the power supplied via the output shaft to the individual motors 20,22 can be stored in the energy storage device 48. When decelerating but the motors 20 and 22 are still providing positive power, the control algorithm can determine the need for a forthcoming down shift, and then command the energy conversion device 42 to generate more than required motoring power. This extra generated power can be briefly stored in the energy storage device 48 for use during the upcoming down shift event. When the down shift occurs, the stored energy is fed to the disengaged motor to return it to its higher synchronized speed for the low range clutch 32 or 37.

If there is no provision for energy storage in the particular design, and the energy conversion device.42 can not absorb energy from the power train, different retarding strategies can be utilized. For instance, when retarding does occur, a resistive grid (not shown) can absorb the retarding energy. In this condition the engine 40 can be throttled back to a lower idle position to conserve fuel as part of a part-throttle algorithm. With a shifting algorithm, the electronic control module 44 determines the shift event and duration, it can also ask the engine 40 to increase its speed to store energy in the engine's flywheel (not shown), and decrease the system lag for the upcoming range shift event.

Those skilled in the art will appreciate that the illustrated concepts can be extended to additional combinations of motors and ranges. For instance, with two motors, additional ranges can be used to increase the speed capability of the conveyance without increasing motor torque speed requirements. On the other hand, with two ranges, two or more motors could be used to suit a particular configuration or use of high motor quantities on a given motor size, or to further lessen torque interruption during a shift event. Smaller motor size can further lessen torque interruption during a shift event and can lead to a smaller package. Synchronized shifts can add smoothness and reduce transmission cooling and mechanical complexity. Sequential shifting, as described above, can offer reduced torque interruption and continued rimpull during the shift event. Transfer of energy between the motors and/or energy storage device can reduce the need to provide engine power changes during shift events and/or dissipate energy during down shifting events. In other words, storing shift energy can decrease fluctuating engine demands. By sensing the motors states, and providing this information to the electronic control module 44, a feed forward control over range shifts as well as engine management can be accomplished as previously described by pre-storing energy in the energy storage device 48 for an upcoming shift event.

It should be understood that the above description is intended for illustrative purposes only, and is not intended to limit the scope of the present invention in any way. Thus, those skilled in the art will appreciate that other aspects of the invention can be obtained from a study of the drawings, the disclosure and the appended claims.

What is claimed is:

1. A torque transmitting power system comprising:
a rotatable output shaft;
a first motor operably coupled to the output shaft via a first transmission that has at least one range;
a second motor operably coupled to the output shaft via a second transmission that has at least two ranges; and
a power supply subsystem including an engine with an output operably coupled to an input of an energy conversion device, which is operably coupled to an input of the first motor and an input of the second motor.

2. The power system of claim 1 wherein the second transmission is electronically controllable; and
an electronic control module in control communication with the second transmission, and including a shift control algorithm.

3. The power system of claim 2 wherein the first transmission is electronically controllable and includes at least two ranges; and
the electronic control module being in control communication with the first transmission.

4. The power system of claim 3 wherein the power supply subsystem includes a common bus operably positioned between the energy conversion device and the inputs of each of the first and second motors.

5. The power system of claim 4 wherein the common bus includes a pressurized hydraulic reservoir;
the energy conversion device includes a pump with and outlet fluidly connected to an inlet of the pressurized hydraulic reservoir; and
the first and second motors are hydraulic motors.

6. The power system of claim 4 wherein the common bus includes an electrical voltage bus;
the energy conversion device includes an electrical generator; and
the first and second motors are electric motors.

7. The power system of claim 4 wherein the power supply subsystem includes an energy storage and retrieval device operably coupled to the common bus.

8. A method of operating a torque transmitting power system, comprising the steps of:
simultaneously engaging first and second motors to an output shaft via first and second transmissions, respectively;
shifting at least in part by sequentially disengaging one, but not both, of the first and second motors from the output shaft via one of the first and second transmissions, respectively;
changing the range of the transmission associated with the disengaged motor; and
re-engaging the one of the first and second motors with the output shaft via the one of the first and second transmissions, respectively.

9. The method of claim 8 wherein the shifting step includes the sequential steps of:
disengaging the other of the first and second motors from the output shaft via the other of the first and second transmissions, respectively;
changing the range of the transmission associated with the disengaged motor; and
re-engaging the other of the first and second motors with the output shaft via the other of the first and second transmissions, respectively.

10. The method of claim 9 including a step of synchronizing a speed of a disengaged motor with the output shaft before the re-engaging step for that motor.

11. The method of claim 10 wherein the synchronizing step includes decelerating the disengaged motor and generating power by the disengaged motor during the deceleration; and
supplying the generated power to at least one of a common bus and an engaged motor.

12. The method of claim 10 wherein the synchronizing step includes accelerating the disengaged motor with power from at least one of the engaged motor and a common bus.

13. The method of claim 10 including the steps of:
maintaining a speed of the first motor below a predetermined first maximum speed; and
maintaining a speed the second motor below a predetermined second maximum speed.

14. The method of claim 8 including a step of operating at least one the first and second motors as an energy conversion device supplied with energy via the output shaft.

15. The method of claim 14 including a step of storing the recovered power in an energy storage device.

16. The method of claim 8 including a step of storing power in an energy storage device before a shift event; and
using at least a portion of the stored power to facilitate the shift event.
